(19) United States
(12) Patent Application Publication
(10) Pub. No.: US 2016/0246322 A1
(43) Pub. Date: Aug. 25, 2016

(54) Unknown

(71) Applicant: W. Gessmann GmbH, Leingarten (DE)

(72) Inventors: Alwin Ehrensperger, Heilbronn (DE); Martin Eggensperger, Heilbronn (DE)

(21) Appl. No.: 15/045,278

(22) Filed: Feb. 17, 2016

(30) Foreign Application Priority Data
Feb. 23, 2015 (EP) 15 156 127.1

(51) Int. Cl. G05G 9/047; H04B 1/3822; G07C 5/00; H04W 76/02; G05D 1/02; G07C 5/08

(52) U.S. Cl. CPC G05G 9/047; G05D 1/02; G07C 5/0808; G07C 5/008; H04W 76/021; H04B 1/3822; G05G 2009/04774; G05G 2009/0474; H04W 84/12

(57) ABSTRACT

An input device (12), in particular, a joystick, for controlling work equipment and vehicles (14), has a control unit (30) integrated in the input device (12), with a data memory (32), with operating software (34) stored in the data memory (32) for generating control signals (36) caused by operating the input device (30), with a hardware interface (38) for outputting the control signals (36), and with a wireless communication interface (44) for a wireless connection of the input device (12) with a mobile terminal unit (16), which is constituted for the diagnosis, maintenance, and/or configuration of the input device (12), or which can be established via a link of the input device (12) with a central processing unit (18) for the diagnosis, maintenance, and/or configuration of the input unit (12). A service device system with at least one such input device is also described.

### BACKGROUND OF THE INVENTION

Mobile work equipment and vehicles, such as for example, forklift trucks, excavators, track-bound powered vehicles or ships, have input devices by means of which the work equipment or vehicles can be controlled by an operator. The input devices can be constituted, for example, as joysticks, drive controllers, or drive-brake controllers. The functions of the input devices available on the market must be freely configurable for great flexibility of use, and therefore frequently have a control unit inside the device with a data memory and with (configurable) operating software stored in the data memory for the input device. In order to output the control signals generated by the input device, a hardware interface is used, via which the input device can be cable-connected to a central electronic control system of the work equipment or vehicle by means of a data cable. The input devices can, for example, be connected via a so-called bus system to the central control system of the work equipment or vehicle.

The input devices usually have to be removed from their mounting position on the work equipment or vehicle for maintenance or configuration of the input device (or of the operating system) and for fault diagnosis. The input devices are subsequently connected to a computer, for example, via a cable to be connected to the hardware interface, so that the service work described above can be performed. This is time-consuming and work intensive and often results in long unwanted downtimes of the work equipment or vehicle.

The object of the invention is therefore to propose an input device as well as a service device system for which fault diagnosis, maintenance, and configuration of the input device is less work intensive and time-consuming and more economical overall.

### SUMMARY OF THE INVENTION

The object relating to the input device is achieved with an input device with the characteristics stated in the independent claim and the object relating to the service device system is achieved with a service device system with the characteristics stated in the associated claims. Preferred further embodiments of the invention are stated in the dependent claims and in the description.

The inventive input device has an integrated, i.e. internal, control unit with a wireless communication interface for a wireless data link between the control unit of the input device and a mobile terminal unit, which is constituted for the diagnosis, maintenance, and/or configuration of the input unit, and/or via which remote access to the control unit of the input device can be established by means of a central processing unit (=diagnosis or maintenance server). In this way, the input device can be subjected to function diagnosis, maintained, and/or its operating parameters configured in a simple and low-cost manner, without the input device having to be removed from its installation position on the work equipment or vehicle. Furthermore, the input device does not have to be connected to the mobile terminal unit via an electric cable, as a result of which the work, time, and cost required is reduced overall for the diagnosis, maintenance, and/or configuration work to be performed in a particular case. There is no need to keep a stock of special connecting cables. Where the input device is connected to the remote processing unit via radio communication, the service tasks can be performed without a service technician with specialized know-how being present on site. In this way, the service tasks can be performed for mobile applications at any time and at any location.

It is important to note that the inventive terminal unit can be maintained, configured, and/or subjected to diagnosis of its configuration or functioning state, irrespective of the operating and functioning state of the central (electronic) control unit of the work equipment/vehicle to which the input device is connected via the hardware interface as well as the data cable connected to it. In this way, unwanted interference from the central control unit can be eliminated and malfunctions of the input device can be detected and eliminated more quickly and reliably. Furthermore, further relevant data of the operating unit, for example, fault logs stored in the data memory of the control unit, operating hours of the input device, or a device identifier, for example, a serial number of the input device can be read out and/or recorded directly by means of the mobile terminal unit or by means of the central processing unit connected via the mobile terminal unit. The recorded operating hours can, for example, in the case of rental work equipment or rental vehicles, be drawn on to invoice the rental and/or wear-and-tear charges or to plan pending maintenance and service assignments or spare part orders. With the inventive input device, the acquisition of information about the current geographic location of the input device and therefore of the work equipment and/or of the vehicle by means of the mobile terminal unit, which is linked by radio to the input device, is possible. Via the wireless communication interface of the input device it is possible, if the hardware interface of the input device is designed for bidirectional data transmission over the data cable to be connected to it, to additionally install firmware updates for other input and/or control devices of the work equipment or of the vehicle from the mobile terminal unit and/or from the central processing unit via the mobile terminal unit into said other input and/or control devices. Furthermore, the control unit of the input device can also be designed and/or programmed for real-time logging of data transfer via the data cable connected to the hardware interface. Via the wireless communication interface of the input device, the reports can easily be transferred—if necessary, in real time—to the mobile terminal unit for further evaluation on the terminal unit or on the central processing unit. In this way, in case of a fault for example, the current bus load on the data cable can be taken into consideration when locating the fault.

According to the invention, the input device can be, in particular, a so-called joystick, a drive controller, a drive-brake controller, or a ship controller.

According to the invention, the wireless communication interface of the control unit inside the device can be a Bluetooth, a near-field communication (NFC), a ZigBee, or a WLAN interface. By deploying such local range radio links it can be ensured that access to the control unit of the input device by means of the mobile terminal unit is only possible from the direct vicinity, i.e. at a distance of less than 10 or 20 meters. In many technical applications of the input device, for example on ships, usually only authorized persons can enter the close vicinity (the so-called local range), of the control console of the work equipment or vehicles, which are equipped with the input device. This helps to avoid unauthorized access to the wireless communication interface of the input device.

According to a preferred further embodiment of the invention, the communication interface can exhibit spatially directional reception and/or emission behavior, in order to permit communication of the input device with the input device only from the defined position of the user relative to the input device. This offers further security advantages against unauthorized remote access to the input device.

For still further improved protection of the input device from unauthorized access via the wireless communication interface, the control unit of the input device can have a power measurement device for determining the power of the radio signals received via the communication interface of the input device. The control unit inside the device is constituted and/or programmed to release wireless remote access to the operating system of the input device only at a defined maximum power or if the received radio signals are below a defined maximum power.

According to the invention, the input device can also have a switch preferably disposed on the housing, with which the wireless communication interface of the input device can be activated and/or deactivated. In the simplest design, the switch can be constituted as a momentary-contact switch or toggle switch. To activate the wireless communication interface, the input unit can alternatively be equipped with a reader for authorization identification, in particular, an RFID chip. Activation of the wireless communication interface by means of an activation code received via the hardware interface of the input device is also conceivable. The activation code might be, for example, a purely numeric or an alphanumeric password. In this case, the control unit of the input device is programmed to compare the received activation code with an authenticated activation code stored in the control unit and to activate the wireless communication interface only if the two codes match.

According to a preferred further embodiment of the invention, the wireless communication interface of the input device can only be activated by applying an electrical supply voltage to the input device, i.e. by switching on the input device (=starting up the input device by “loading” the operating system). In this case, the control unit can, in particular, be constituted to activate the wireless communication interface for a defined time period only, for example, for less than two to five minutes, and to deactivate it again at the end of this time period.

Protection of the input device from unauthorized access can, irrespective of the activation mode of the wireless communication interface, always be improved by programming the control unit to deactivate the wireless communication interface of the input device automatically, in particular, after a defined activation period of the wireless communication interface has expired.

The wireless communication interface of the input device can alternatively also be deactivated by a radio signal from the mobile terminal unit received via the communication interface.

According to a preferred further embodiment of the invention, the control equipment is programmed to deactivate the wireless communication interface when the user manually operates the input unit.

According to the invention, a device identifier, for example, a unique serial number for the unique identification of the device, can be stored in the electronic memory of the input device. This enables device-specific diagnostic, maintenance, or configuration data to be called up or selected faster on the input device or on the central processing unit wirelessly connected to the input device. In this case, the control unit is preferably programmed to transmit the device identifier while or after a radio link with the mobile terminal unit is established.

An even higher level of security against unauthorized access to the control unit of the input device can be achieved according to the invention by programming the control unit in such a way that access to the operating system of the input unit is permitted only after authentication of the mobile input device or of the operator as having access authorization toward the control unit. For this, an authentication code, for example, can be stored in the control unit or in the data memory of the input device. In this case, the control unit can be programmed to enable access to the operating system of the input device via the wireless communication interface only after a code that matches the authentication code has been transferred.

To minimize the risk of interference of the input device on a central control device of the work equipment or vehicle connected to the input device via the hardware interface, it has proven to be advantageous if the control unit of the input device is programmed to deactivate the hardware interface of the input device only when required. This can be the case, in particular, when activating the wireless communication interface of the input device, or when establishing a radio link between the mobile terminal unit and the input device, or when installing new operating software, or when configuring the existing operating software.

The inventive service device system comprises at least one input device as described above and a mobile terminal unit with a CPU, a data memory, and application software stored in the data memory. The mobile terminal unit has a first wireless data transfer interface, via which a (radio) data link can be and/or is established with the first communication interface, and wherein the application software is constituted for the diagnosis, maintenance, and/or configuration of the input device, i.e. its operating software. Alternatively or additionally, the mobile terminal unit can have a second wireless data transfer interface, which differs from the first wireless data transfer interface. The application software of the mobile terminal unit can in this case be set to connect the control unit of the input device via the second wireless data transfer interface to a central processing unit for the diagnosis, maintenance, and/or configuration of the input device. This can be achieved via a satellite radio network or another mobile wireless network, in particular, according to the GSM, LTE, or another suitable wireless communication standard. The inventive service device system permits overall faster, more flexible maintenance and possibly (re-)configuration of the operating software as well as more simple diagnosis of malfunctions of the input device. Thus, for example, the data mentioned above, i.e. in particular the serial number of the input device, (real-time) logs of a data transfer via the data cable (bus load) connected to the hardware interface, operating hours of the input device or error logs can be read out via the mobile input device or the central processing unit connected to it.

Moreover, a geographic position of the input device can be determined in a simple manner via a GPS module or connection of the mobile terminal unit with a radio relay station. This is, in particular, advantageous for planning service tasks or the planned replacement of an input device.

The inventive service device system also permits the maintenance, configuration, and fault and function diagnosis of further (input) devices, which differ from the inventive input device, and which are linked directly or indirectly to the input device via a data cable (for example, a bus cable) of the work equipment or vehicle, which is connected to the hardware interface of the input device. It goes without saying that, in this case, the hardware interface as well as the control unit inside the input device as well as the further (input) devices must be configured for bidirectional data transfer.

The inventive service device system can, in particular, also comprise a plurality of the aforementioned inventive input devices. In this case, multiple input devices can, independently of each other, be maintained, configured, and faults analyzed and eliminated in a low-cost and simple way via the mobile input unit.

In the case of security-relevant applications of the input device, according to the invention any data transfer between the input device and the mobile terminal unit and/or the central processing unit can be encrypted.

The invention is explained in more detail by means of an example shown in the drawings.

The drawings show

### BRIEF DESCRIPTION OF THE DRAWING

FIG. 1 A service device system with an input device constituted as a joystick, whose internal control unit has a hardware interface for control signals generated by the input device and a wireless communication interface, via which the input device can be connected to a portable computer for the fault diagnosis, maintenance, and/or configuration of the input device; and

FIG. 2 A further service device system with multiple input devices.

### DESCRIPTION OF THE PREFERRED EMBODIMENT

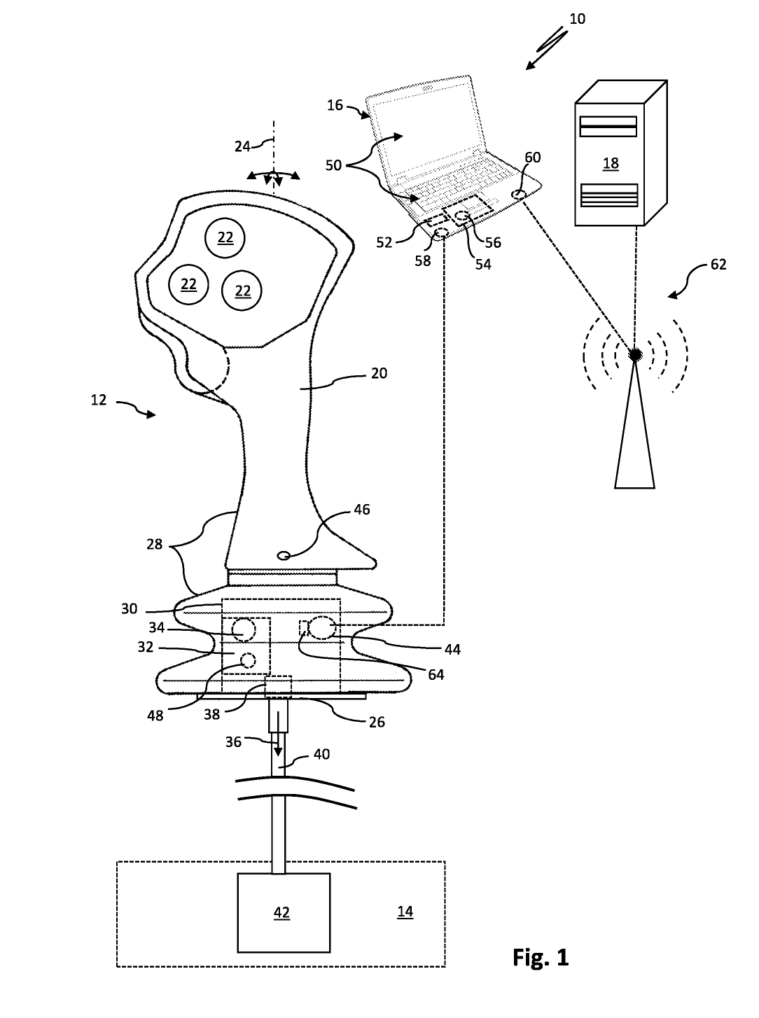

FIG. 1 shows a service device system 10 with an input device 12 for controlling work equipment or a vehicle 14, a mobile terminal unit 16, and a central processing unit 18 for the diagnosis, maintenance, and/or configuration of the input device 12. The input device 12 can, for example, be constituted as a drive controller, as a drive-brake controller, as a ship controller, or, as is shown in FIG. 1, as a joystick.

The input device 12 has a handle 20 for the hand of an operator. The handle 20 has multiple switches 22 and for control tasks can be moved out of the depicted neutral position in several axes relative to its longitudinal axis 24 with respect to a mounting or installation panel 26, as is indicated by the two double arrows. The mounting or installation panel 26 is used to install or mount the input device 12 on an instrument panel, control panel, or similar. It is understood that instead of an installation or mounting panel, a frame or similar can be provided.

A housing of input device 12 is identified by 28. The input device 12 has a separate control unit 30 inside the housing, i.e. disposed inside housing 28, which is indicated by a dashed line in the figure. The control unit 30 is, in other words, a module that is integrated in input device 12. Thus, the input device 12 and the control unit 30 together constitute a single unit.

The control unit 30 comprises an electronic data memory 32 and operating software 34 stored in data memory 32 for operating input device 12. By means of the (modifiable) operating software 34, configuration data and/or operating parameters of input device 12 can be freely configured and/or defined. For example, the operating software 28 can comprise characteristics for generating control signals as a function of a corresponding deflection angle of the handle 20 from its neutral position or the corresponding acceleration of the handle. Furthermore, by means of the operating software, a defined control function can be assigned to the switches 16 or the function assignment of the switches can be freely defined. In this way, the functionality of the input device 12 can adapted when required.

The control unit 30 of the input device 12 has a hardware interface 38 for outputting the control signals 36. The hardware interface 38 can, for example, be linked via a data cable 40 connected to the hardware interface 38 to a central control unit 42 of the work equipment or the vehicle 14.

The control unit 30 of the input device 12 has, besides the hardware interface 38, a wireless communication interface 44 for wireless data exchange between the input device 12 and the mobile terminal unit 16. The wireless communication interface 44 can, for example, be constituted as a Bluetooth, a near-field communication (NFC), a ZigBee, a WLAN interface, or an optical communication interface. For the manual activation or deactivation of the wireless communication interface 44, the input device 12 can be equipped with a switch 46 disposed on the housing.

In the control unit 30, an individual device identifier 48, in particular, a digital serial number, can be stored for the unique identification of the input device 12 to the mobile terminal unit 16. The control unit of the input device 12 can in this case be programmed to transmit the device identifier 48 to the mobile terminal unit 14 while or after a radio link with the mobile terminal unit 14 is established.

The control unit 30 of the input device 12 can for security reasons be programmed to deactivate the hardware interface 38 while a radio link is being established with the mobile terminal unit 16. During configuration or maintenance of the input device 12, this can prevent output of unwanted signals via the hardware interface 38 to the central control device 42 of the work equipment or vehicle 14.

The mobile terminal unit 16 can be, as shown in FIG. 1, a portable computer or a tablet computer or a mobile telephone. The mobile terminal unit 16 has an input and display unit 50, a CPU 52, a data memory 54, and application software 56 stored in data memory 52. A first wireless data transfer interface 58 of the terminal unit is used to establish the wireless (local-range) data link with the input device 12. The application software 56 is used for the diagnosis, maintenance, and/or configuration of the input device 12 or its operating software 34.

In the example shown, the mobile terminal unit 16 is provided with a further wireless data transfer interface 60, which differs from the first data transfer interface 58. The second wireless data transfer interface 60 of the mobile terminal unit 16 can be, for example, a satellite radio interface or another mobile radio interface, for example, according to the GSM, GPRS, EDGE, UMTS, HSDPA, or the LTE standard.

The mobile terminal unit 16 and/or the application software 56 are in this case established to connect the control unit 30 of the input device 12 via the second wireless data transfer interface and each mobile radio network 62 with the remote processing unit 18, for the diagnosis, maintenance, and/or configuration of the input device. In this way, no specific know-how is required to perform the service tasks on the input device. The remote processing unit can, for example, be located at the manufacturer of the input device 12 or at a service partner. In this case, the mobile terminal unit 16 essentially functions as a relay and/or switchover device for establishing a data connection between the central processing unit and the input device 12.

The wireless communication interface 44 of the input device 12 can for security reasons exhibit spatially directional receiving and/or emission behavior. In this way, a radio link between the mobile terminal unit 16 and the input device 12 can only be established from a defined spatial position relative to the input device 12.

Moreover, the control unit 30 of the input device 12 can have a power measurement device 64 for determining the power of the radio signals received via the communication interface 44 of the input device 12. In this case, the control unit 30 is programmed to release wireless access to the operating software 34 of the input device 12 only if radio signals are output whose power output is equal to or less than a defined maximum radio signal power output.

To further secure the input device 12 from unauthorized wireless access, the control unit 30 can be programmed to deactivate the wireless communication interface 44 automatically, for example, after a defined maximum activation period has expired. Alternatively or additionally, the wireless communication interface 44 can also be deactivated by a signal from the mobile terminal unit 16 received via the communication interface 44. Data exchange between the input device 12 and the mobile terminal unit 16 or the remote processing unit 18 can be encrypted.

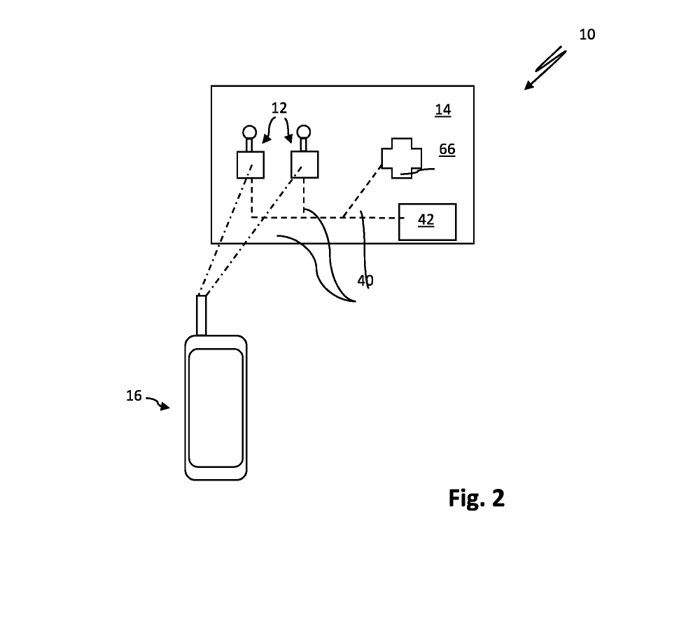

In FIG. 2, a service device system 10 is shown schematically, which essentially differs from the service device system described above in the context of FIG. 1, in that it comprises two input devices 12, which are used to control the work equipment or vehicle 14. The control units 30 of the two terminal units 12 are each connected via the hardware interface (FIG. 1), and the data cable 40 connected to it, of the work equipment or vehicle 14 with the central control unit 42 of the work equipment/vehicle 14. The data cable 40 can, in particular, be constituted as a data bus (bus cable). The mobile terminal unit 16 is in this example implemented as a so-called smart phone.

The mobile terminal unit 16 can be linked to a central processing unit (not shown) in a way that corresponds to the service device system shown in FIG. 1. By means of the terminal unit 16, the diagnosis, maintenance, and/or configuration of the two input devices 12 can be performed with a time delay. Furthermore, with the mobile terminal unit 16 information about the data flow on the bus cable, for example, the bus load, as well as to additional devices 66 connected to the data cable 40 or to the central control unit 42 of the work equipment/vehicle 14, for example, drive controllers, drive-brake controllers and similar, can be obtained as soon as a corresponding wireless data link from the mobile terminal unit 16 has been established with one of the input devices 12 of the work equipment/vehicle 14. The mobile terminal unit 16 can, if the application software (FIG. 1) or a central processing unit (FIG. 1) connected to the mobile terminal unit 16 is appropriately configured, also be used for the maintenance, diagnosis, and/or configuration of the further devices 66. This is possible irrespective of whether they are connected via the data cable or another interface on the central control unit 42 of the work equipment/vehicle 14.

1-12. (canceled)

13. An input device structured as a drive controller or drive-brake controller for controlling work equipment and vehicles, the input device having a housing and a control unit integrated in the housing to constitute a single unit, wherein the control unit comprises:
a data memory;
operating software stored in said data memory for generating control signals caused by operating the input device;
a hardware interface for outputting the control signals via a data cable of the work equipment or vehicle, the data cable being structured for connection to said hardware interface; and
a wireless communication interface for wireless connection of the input device with a mobile terminal unit, the mobile terminal unit being structured for diagnosis, maintenance and/or configuration of the input device and/or structured to establish a link between the input device and a central processing unit for diagnosis, maintenance and/or configuration of the input device.

14. The input device of claim 13, wherein said wireless communication interface of the control unit of the input device is a Bluetooth, a near-field communication (NFC), a ZigBee, a WLAN interface or an optical communication interface.

15. The input device of claim 13, wherein said wireless communication interface of the input device is activated and/or deactivated by means of a switch disposed on the housing.

16. The input device of claim 13, wherein the control unit is programmed to deactivate said wireless communication interface automatically.

17. The input device of claim 13, wherein the control unit is programmed to deactivate said wireless communication interface after a defined activation period of the wireless communication interface has expired.

18. The input device of claim 13, wherein said wireless communication interface is deactivated by a radio signal from the mobile terminal unit received via said communication interface.

19. The input device of claim 13, wherein an individual device identifier is stored in the control unit, the control unit being programmed to transmit said device identifier while or after a radio link between the input device and the mobile terminal unit is established to the mobile terminal unit.

20. The input device of claim 13, wherein the control unit is programmed to deactivate said hardware interface of the input device when a radio link with the mobile terminal unit is established.

21. The input device of claim 13, wherein the input device is a joystick, a drive controller, a drive-brake controller or a ship controller.

22. A service device system with at least one input device as claimed in claim 13, wherein the mobile terminal unit comprises CPU, a data memory, and application software stored in the data memory, wherein the mobile terminal unit has a first interface via which a wireless data link with said communication interface of the input device is established, wherein
a) the application software is constituted for diagnosis, maintenance, and/or configuration of the input device, and/or
b) the mobile terminal unit has a second interface, which differs from the first interface, the application software being implemented to connect the control unit of the input device via the second interface with a central processing unit for the diagnosis, maintenance and/or configuration of the input device.

23. The service device system of claim 22, wherein the service device system comprises a plurality of input devices.

24. The service device system of claim 22, wherein the application software is constituted for time-delayed diagnosis, maintenance and/or configuration of the input device.

25. The service device system of claim 22, wherein data transfer via the wireless communication interface of the input device and the first interface of the mobile terminal unit is encrypted.

26. The service device system of claim 22, wherein the mobile terminal unit is a portable computer or a mobile telephone.
